(19) United States
(12) Patent Application Publication
(10) Pub. No.: US 2010/0116895 A1
(43) Pub. Date: May 13, 2010

(54) DEVICE AND METHOD FOR CONTROLLING THE WATER TEMPERATURE ON AT LEAST ONE WATER OUTLET

(76) Inventor: Gerald Kures, Wien (AT)

Correspondence Address: LADAS & PARRY LLP, 224 SOUTH MICHIGAN AVENUE, SUITE 1600, CHICAGO, IL, 60604, US

(21) Appl. No.: 12/532,677

(22) PCT Filed: Mar. 20, 2008
(86) PCT No.: PCT/AT08/00101

§ 371 Date: Nov. 13, 2009

(30) Foreign Application Priority Data
Mar. 26, 2007 (AT) A 469/2007

(51) Int. Cl. G05D 23/185; G05D 23/12

(52) U.S. Cl. 236/12.11; 236/12.13

(57) ABSTRACT

The invention relates to a device and a method for controlling the water temperature on at least one water outlet of a water line comprising a safety mixing valve having a warm water inlet and a cold water inlet, with which a predetermined temperature of the mixed water coming from the water line can be set and with which water flow is prevented if the predetermined water temperature is exceeded. A bypass line having a valve is associated with the safety mixing valve such that, if the valve is in an open position, the warm water is guided to the water outlet by bypassing the safety mixing valve.

The invention relates to a device for controlling the water temperature on at least one water outlet of a water pipe comprising an overheat-protected safety mixing valve, having a hot water inlet and a cold water inlet, with which a predetermined mixing temperature of the mixed water coming from the water pipe can be set, so that for protection against scalding the outlet of mixed water is safeguarded at the predetermined temperature and with which a water passage is prevented if the predetermined water temperature is exceeded.

In order to prevent the risk of scalding for the user of hot water fittings, the hot water circuit is generally fed with water at a temperature of ca. 50° C.

Additionally, safety mixing valves are known which comprise a cold water inlet and a hot water inlet, so that the output of mixed water is safeguarded at a predetermined temperature. Such safety mixing valves are generally pre-set in the factory in a temperature range of between 30° C. to 60° C. and may not be adjusted or only with difficulty (by specialist personnel); the mixing temperature may vary by up to 5 K. Such safety valves are protected against overheating, so that a water passage is prevented if a predetermined temperature is exceeded.

In order, wherever possible, to keep the number of legionella contained in water pipes low, as said legionella are pathogens for diseases, in particular legionella pneumophila, generally the temperature of the hot water circuit is cyclically raised to ca. 70° C. in order to kill the legionella. Such an increase is carried out at various intervals according to the location and/or purpose of use. Thus it is carried out in the domestic field usually approximately every 10 days, and in hospitals generally as soon as a given characteristic value is exceeded.

If a safety valve is provided in the water pipe, said water pipe is only thermally disinfected inadequately, as when raising the hot water circuit to 70° C., the predetermined water temperature of the safety mixing valve is exceeded, and thus a water flow through the safety mixing valve is prevented. Thus it is a drawback that the water pipe between the safety mixing valve and the water outlet is not thermally disinfected.

If no such safety valve is provided, again the risk of scalding is a drawback if the hot water outlet is opened by a user during the raising of the temperature of the hot water circuit to approximately 70° C., which is generally carried out during the night.

On the other hand, thermostatic mixing valves are known which have no overheat protection and which merely have one mechanical temperature regulator.

Thus, for example, from DE 10 2004 014 126 B3 a sanitary fitting for flush mounting is known, in which a shut-off device is provided in the form of a magnetic valve. The fitting additionally has a mixing device, for example in the form of a thermostatic valve, which may be actuated by means of a handle. In order to permit a thermal disinfection of the fitting, a bypass valve is provided through which the hot water required for the disinfection runs. An overheat protection against the flow of hot water at over 60° C. is in this case, however, not provided, so that the risk of scalding exists.

Furthermore, a device for the thermal disinfection of a sanitary fitting comprising a hot water connection is known from DE 101 56 224. Also in this case, a hot water supply line has a disinfection bypass line, in which a magnetic valve is received, which is controlled via a control device, according to a temperature measured via a temperature sensor; an overheat protection is also not provided.

A similar fitting comprising a commercially available mixing device without overheat protection is disclosed in DE 296 22 320 U1. Also in this case, a specific hot water disinfection line is itself associated with the fitting and/or the water removal valve.

From CH 638 909 A a thermoscopic unit is known which, however, also does not have an overheat-protected safety valve.

The object of the present invention is accordingly to provide a specific thermal disinfection of water pipes for combating legionella so that, on the one hand, the entire water pipe is disinfected and, on the other hand, the risk of scalding the end user is prevented.

This is achieved in the device of the aforementioned type, by a bypass line having a valve being associated with the overheat-protected safety mixing valve, so that if the valve is in an open position, the hot water is guided to the water outlet by bypassing the safety mixing valve. By the provision of a bypass line, the entire water pipe may be specifically filled with hot water heated to approximately 70° C. and thus within the shortest time the disease-causing legionella are killed. By a selective opening and/or closing of the valve in the bypass line, possible users of the water outlet may be forewarned that the valve has been moved into the open position and thus the risk of scalding can be prevented. Advantageously, therefore, the bypass line may be opened at a time when it is guaranteed that a consumer will not open the water outlet, i.e. when it is ensured that pupils are no longer present in a school, when it is ensured that a hotel guest is not present in a hotel bedroom, etc.

In order to prevent reliably a through-flow from the cold water side to the hot water side and/or vice versa, it is advantageous if the safety mixing valve has at least one anti-backflow device.

In order to achieve in a simple manner an opening and/or closing of the valve in the bypass line, it is advantageous if a control unit is associated with the valve in the bypass line, via which an open and/or closed position of the valve is regulated and/or controlled. In this case, for example an electric, pneumatic, electromagnetic or hydraulic actuating device may be associated with the control unit, the control device being able to be configured to be activated in a time-controlled manner and/or remote-controlled manner, for example via radio, infrared or ultrasound. Additionally it is possible that the control unit is provided, for example, with magnetic card encoding, so that said control unit may be operated only by specific users, for example cleaning personnel. Also the activation of the control device by means of a (removable or non-removable) key is conceivable. When actuating the control unit, additionally an (optical or acoustic) warning signal may be activated, so that possible end users are reliably warned that a thermal disinfection will now take place. A recording of the disinfection processes is also possible via the facility management system. The valve in turn may, for example, be configured as a ball valve, gate valve, thermostatic valve, throttle valve or straight-way valve, respectively with or without auxiliary power and/or also as a temperature safety valve. Naturally, it is also possible that the valve may be actuated mechanically and/or manually.

If a plurality of water pipes are respectively provided with at least one water outlet and one bypass line, a common control unit being provided for opening and closing the valves in the bypass lines, by the actuation of a single control unit advantageously a plurality of bypass lines may be opened and/or shut off.

The method of the aforementioned type is characterized in that the flow path of the hot water to the water outlet may be set such that the hot water is selectively guided unmixed to the water outlet. By this method, in which hot water is selectively guided unmixed to the water outlet, the aforementioned object of combating legionella and at the same time protection against scalding are also achieved. With regard to further advantages, reference may be made to the effects mentioned above in connection with the device according to the invention.

The invention further relates to a modular unit for use in a device according to the invention, in which a safety mixing valve and a bypass line are provided with a valve, so that in an open position of the valve a flow path is opened up by bypassing the mixing valve. As a result of the configuration as a modular unit, conventional water pipes may in a simple manner be retrofitted with the safety mixing valve comprising a bypass line and the aforementioned advantageous effects may be achieved with regard to protection against scalding and combating legionella. Additionally, the device according to the invention may also be incorporated in a shut-off member at the water outlet, i.e. of an outlet fitting.

The invention is described in more detail hereinafter with reference to preferred embodiments shown in the drawings, to which the invention is not intended to be restricted. In detail in the drawings:

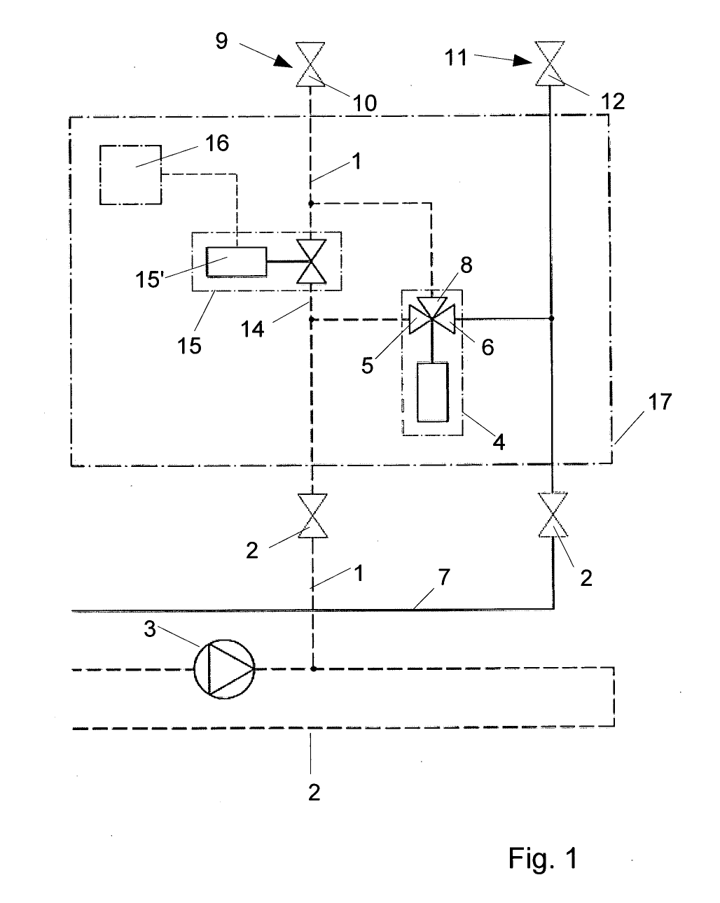

FIG. 1 shows schematically a hydraulic circuit diagram of a hot water circuit, with a safety mixing valve and a bypass line comprising a valve;

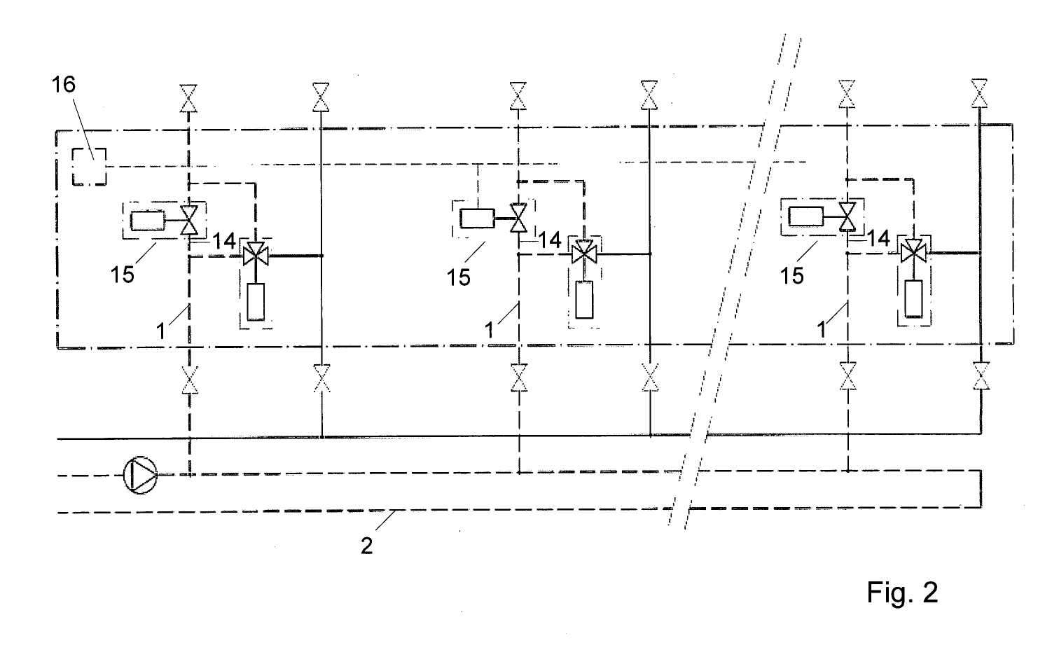

FIG. 2 shows schematically a hydraulic circuit diagram with a plurality of hot water pipes connected to a hot water circuit;

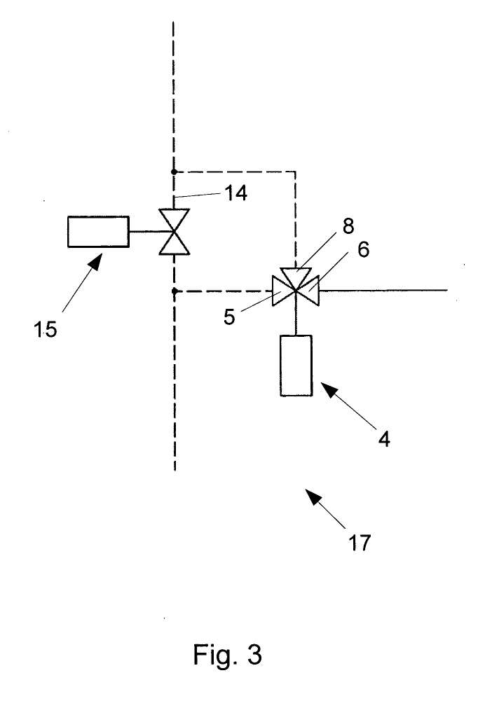

FIG. 3 shows schematically a modular unit comprising a safety mixing valve and a bypass line comprising a valve; and

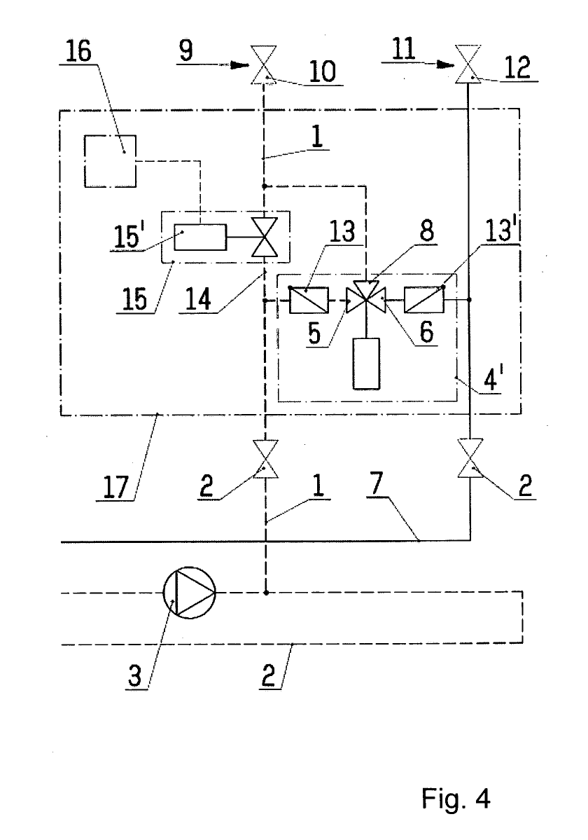

FIG. 4 shows a hydraulic circuit diagram similar to FIG. 1, but with an anti-backflow device.

In FIGS. 1 and 4 a water pipe 1 is visible which is connected to a hot water circuit 2, which is provided with a pump device 3. In the (hot) water pipe 1 a valve 2 is provided and subsequently a safety mixing valve 4 having a hot water inlet 5 and a cold water inlet 6.

The cold water inlet 6 is connected to a cold water pipe 7, which also comprises a valve 2. On one outlet side 8 of the safety mixing valve 4 the mixed water emerges, which is then fed back into the water pipe 1 and thus reaches the water outlet 9 which is provided with a shut-off member 10. The cold water line 7 also has a cold water outlet 11, which is provided with a shut-off member 12. In FIG. 4 anti-backflow devices 13, 13′ are additionally shown in order to prevent water flowing from the hot water circuit into the cold water circuit and vice versa.

In order to be able to achieve a thermal disinfection of the entire water pipe 1 as far as the water outlet 9, a bypass line 14 is provided parallel to the safety mixing valve 4, via which the water supplied from the hot water circuit 2 is guided directly to the water outlet 9. In order to be able to adjust selectively a flow of the hot water via the bypass line 14, a valve 15 is provided with an actuating device 15′ which is activated by a control unit 16. Via the control unit 16, which in particular activates the electrically-, electromagnetically-, pneumatically- or hydraulically-activated actuating device 15′, the bypass line 14 may thus be closed, so that in “normal operation” the hot water is guided via the safety mixing valve 4 and mixed with cold water from the cold water pipe 7, in order to prevent scalding. Via the control unit 16 the valve 15 may then be moved into an open position, for example, in a time-controlled or radio-controlled manner and/or via manual activation, for example, by means of magnetic cards or keys, so that for the thermal disinfection of the water pipe 1 the bypass line 14 is opened up.

As visible in particular in FIG. 3, the entire unit may thus be configured as a modular unit 17, so that a retrofitting of existing water pipes 1 is possible in a simple manner. The unit 17 comprises, in particular, the safety mixing valve 15 with a hot water inlet 5, a cold water inlet 6 and a mixed water outlet 8 as well as the bypass line 14, in which the valve 15 is received.

In FIG. 2 it is visible schematically that by means of a single control unit 16 a plurality of valves 15 may be activated, which are respectively arranged in a bypass line 14 associated with a (hot) water line 1. Thus via the activation of a single control unit, the opening and/or closing of a plurality of bypass lines 14 is possible so that when the hot water circuit 2 is raised to a higher temperature of, for example, 70° C., at the same time the thermal disinfection of a plurality of water pipes 1 is possible.

1. A device for controlling the water temperature on at least one water outlet of a water pipe comprising an overheat-protected safety mixing valve, having a hot water inlet and a cold water inlet, with which a predetermined mixing temperature of the mixed water coming into the water pipe can be set, so that for protection against scalding the outlet of the mixed water is safeguarded at the predetermined temperature, and with which a water passage is prevented if the predetermined water temperature is exceeded, wherein a bypass line having a valve is associated with the overheat-protected safety mixing valve, so that if the valve is in an open position the hot water is guided to the water outlet (9) by bypassing the safety mixing valve.

2. The device according to claim 1, wherein the safety mixing valve has at least one anti-backflow device.

3. The device according to claim 1 wherein a control unit is associated with the valve in the bypass line, via which an open and/or closed position of the valve is regulated and/or controlled.

4. The device according to claim 1, wherein a plurality of water pipes are respectively provided with one water outlet and one bypass line, a common control unit being provided for opening and/or closing the valves in the bypass lines.

5. A method for controlling the water temperature on a water outlet, the hot water and cold water being mixed with one another for achieving a temperature at the water outlet which is pre-set in the factory to a substantially constant mixing temperature in the temperature range of between 30° C. and 60° C., and with which a water passage is prevented if the predetermined water temperature is exceeded, wherein the flow path of the hot water to the water outlet can be set such that the hot water is selectively guided unmixed to the water outlet.

6. A modular unit for use in a device according to claim 1, wherein a safety mixing valve and a bypass line are provided with a valve, so that in an open position of the valve a flow path is opened up by bypassing the mixing valve.
